(19) United States
(12) Patent Application Publication
(10) Pub. No.: US 2005/0080749 A1
(43) Pub. Date: Apr. 14, 2005

(54) System and method for real time adaptive class and special services determination

(75) Inventors: Robert H. Kummer JR., Southbury, CT (US); Jacques E. Hasbani, Easton, CT (US); Linda S. Lin, Easton, CT (US)

Correspondence Address: Brian A. Lemm;Pitney Bowes Inc., 35 Waterview Drive, P.O. Box 3000, Shelton, CT, 06484, US

(73) Assignee: Pitney Bowes Incorporated, Stamford, CT (US)

(21) Appl. No.: 10/681,724

(22) Filed: Oct. 8, 2003

(51) Int. Cl. G06F 17/60

(52) U.S. Cl. 705/400

(57) ABSTRACT

The present invention relates to a method for processing a plurality of mail pieces that is able to make appropriate class of service determinations during processing based on a first class of service received from a user and a measured weight and dimension(s) of each mail piece. If the first class of service is determined to not be appropriate, a second, appropriate, class of service is determined for the each mail piece using the measured weight and dimension(s). A postage amount is determined for each mail piece using the measured weight and dimension(s) and the appropriate class of service. The method may further include determining whether each of a number of requested special services is applicable to each mail piece so that special service fees may be applied in a discriminate manner. More accurate transaction information may thus be stored for each mail piece.

### FIELD OF THE INVENTION

The invention disclosed herein relates generally to mailing processing systems, and more particularly to a system and method for adapting class of service designations for mail and applying selected special services to mail in a discriminate manner.

### BACKGROUND OF THE INVENTION

Mail processing systems, such as, for example, a mailing machine, often include different modules that automate the processes of producing mail pieces. The typical mailing machine includes a variety of different modules or sub-systems, each of which performs a different task on the mail piece. The mail piece is conveyed downstream utilizing a transport mechanism, such as rollers or a belt, to each of the modules. Such modules could include, for example, a singulating module for separating a stack of mail pieces such that the mail pieces are conveyed one at a time along the transport path, a stripping/moistening module for stripping open the flap of an envelope, and wetting and sealing the glued flap of an envelope, a weighing module for weighing the mail piece, and a metering/printing module, for storing postage and applying evidence of postage to the mail piece. The mailing machine is controlled by a central processing unit that executes software that is stored in memory provided in the mailing machine. The exact configuration of the mailing machine is, of course, particular to the needs of the user.

Postal authorities publish postage rate schedules based on a variety of parameters, such as the weight and/or dimensions of the mail piece, the origin and/or destination of the mail piece and the class of mail being used. A mailing machine as described above typically stores a series of tables corresponding to the published rate schedules. In operation, a user weighs a mail piece and selects a class of service for the mail piece and then feeds the mail piece through the mailing machine. The mailing machine determines the proper postage for the mail piece based on the stored tables and the measured weight and chosen class of service and prints the proper postage either directly on the mail piece or on a tape to be applied to the mail piece. The user may also designate one or more special services to apply to each mail piece. These special services typically involve some special treatment that the mail piece is to receive, such as, for example, c.o.d. service, return receipt service or insurance, among others. Each designated special service requires an additional fee, which is included in the postage amount that is printed in a postage indicia for the mail piece.

Certain mail processing systems include technology that allows continuous processing of mixed mail, meaning mail pieces having different weights and dimensions, including length, width and thickness, without the need to manually sort the mail based on weight and/or dimension. In such systems, as the mail pieces are conveyed through the system, they are automatically weighed and measured and a postage rate is determined from one or more stored rate tables based on the measured weight and dimensions and a class of service entered by the user. If one or more special services are requested by the user, the postage rate is also based on the requested special services. The mail processing system then applies the determined postage to each mail piece, either by printing a postage indicia directly on the mail piece or on a tape to be adhered to the mail piece. Examples of such a mail processing system are the DM Series™ Digital Mailing Systems sold by the assignee of the present application.

Current mail processing systems, however, are only able to process batches of mail in a single class of service selected by a user. In other words, the mail must first be sorted according to class, and postage is determined and applied for each mail piece for the selected class based on measured weight and dimension parameters and selected special services. This is the case because current mail processing systems are not equipped to make class determinations during the processing of the mail. As a result, current mail processing systems are not able to process batches of mail that vary by weight and/or one or more dimensions over several classes. In addition, in current mail processing systems, fees for special services selected by the user are applied indiscriminately, meaning they are included in the postage amount even if a particular mail piece does not qualify for the selected special service. As a result, transaction information that is captured for reporting and/or accounting purposes is often inaccurate because it includes special services that were paid for but not actually applied to certain mail pieces. Thus, there is a need for a mail processing system and method that is able to process batches of mail that vary by weight and/or one or more dimensions over a number of classes and make class of service determinations during the processing. There is also a need for a system and method that is able to apply selected special services in a discriminate manner only where the special service is determined to be applicable to the mail piece in question.

### SUMMARY OF THE INVENTION

The present invention relates to a method for processing a plurality of mail pieces that is able to make appropriate class of service determinations during processing. According to the method, a first class of service for processing the plurality of mail pieces is received from a user. Next, a weight and one or more dimensions of a selected mail piece and is determined and a further determination is made as to whether the first class of service received from the user is appropriate for the selected mail piece using the determined weight and the determined one or more dimensions. If the first class of service is not appropriate, the method includes determining a second class of service for the selected mail piece using the determined weight and the determined one or more dimensions, wherein the second class of service is appropriate for the selected mail piece. A final class of service is then set for the selected mail piece. The final class of service is set to the first class of service if the first class of service was determined to be appropriate and is set to the second class of service if the first class of service was determined to not be appropriate. A postage amount is then determined for the selected mail piece using the determined weight, the determined one or more dimensions and the final class of service. The determined postage amount is applied to either the selected mail piece or a tape to be applied to the selected mail piece. Each of these steps is then repeated for the remaining mail pieces in the batch.

The method may further include receiving one or more special services to be applied to the plurality of mail pieces. In this embodiment, the method further includes determining whether each of the special services is applicable to the selected mail piece and generating a list of applicable special services for the mail piece, wherein the determined postage amount is also based on the generated list of applicable services. The applicability of each of the special services may be based on the final class of service, the determined weight, the determined one or more dimensions, and a separate determination as to whether all applicable prerequisite requirements for the special service have been satisfied. Transaction information may be stored for each mail piece, which transaction information may include the determined postage, the final class of service, and, if appropriate, the list of applicable special services.

The present invention also relates to a mail processing system that includes a metering/printing module for applying postage values to a mail piece, a weighing module for weighing a mail piece, a dimensioning module for determining one or more dimensions of a mail piece, a central processing unit controlling operation of the metering/printing module, the weighing module and the dimensioning module, and a memory storing postage rating information and software that is executable by the central processing unit. The software includes, in various embodiments, instructions for executing the method of the present invention described above.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is an isometric view of a mail processing system according to the present invention;

FIG. 2 is a block diagram of the mail processing system of FIG. 1;

FIG. 3 is a flow diagram illustrating the operation of the mail processing system according to the present invention that is capable of processing batches of mail that vary by weight and/or dimension over a number of classes and applying selected special services in a discriminate manner;

FIG. 4 is a flow diagram of a preferred method of determining appropriate classes of service for mail that may be implemented in the mail processing system of the present invention; and

FIG. 5 is a flow diagram of a preferred method of determining whether selected special services are applicable to pieces of mail in a batch of mail that may be implemented in the mail processing system of the present invention.

### DETAILED DESCRIPTION OF THE PREFERRED EMBODIMENTS

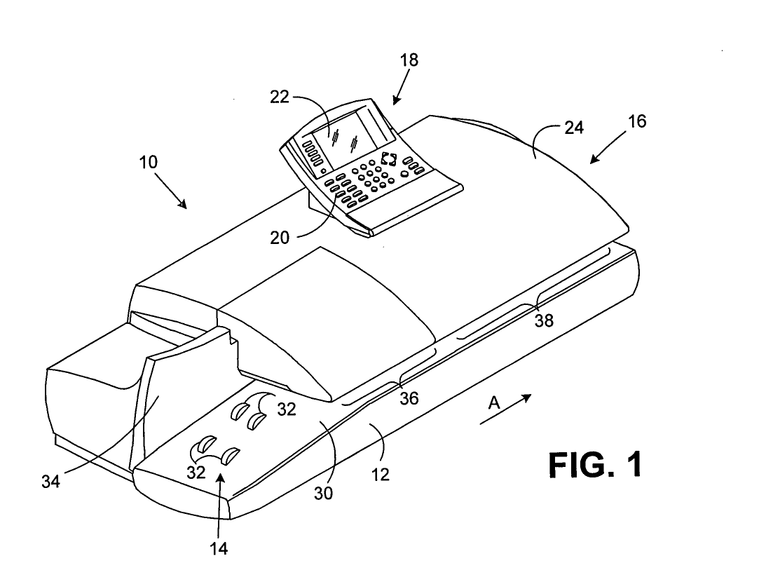

Referring to FIG. 1, an isometric view of a mail processing system 10, such as a mailing machine, according to the present invention is shown. Mailing processing system 10 comprises a base unit, designated generally by the reference numeral 12, the base unit 12 having a mail piece input end, designated generally by the reference numeral 14 and a mail piece output end, designated generally by the reference numeral 16. A UIC 18 is fixedly mounted on the base unit 12, and includes one or more input/output devices, such as, for example, a keyboard 20 and a display device 22. One or more cover members 24 are pivotally mounted on the base 12 so as to move from the closed position shown in FIG. 1 to an open position (not shown) so as to expose various operating components and parts for service and/or repair as needed.

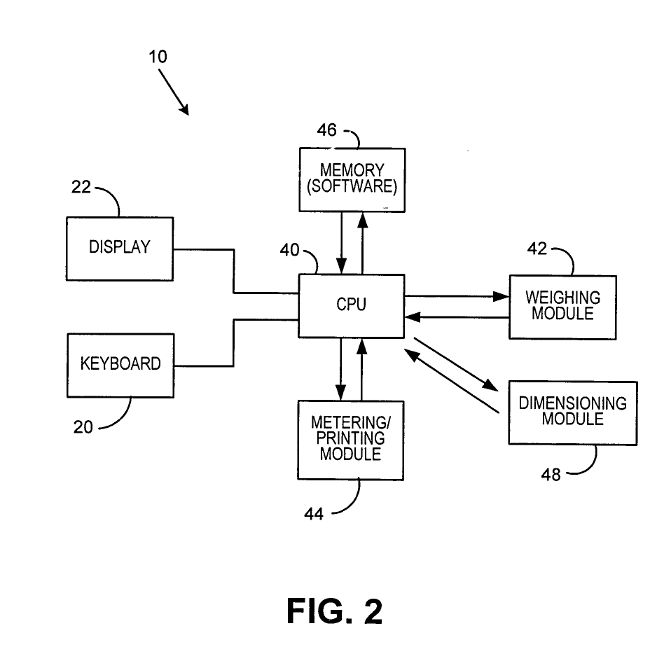

The base unit 12 further includes a horizontal feed deck 30 that extends substantially from the input end 14 to the output end 16. A plurality of nudger rollers 32 are suitably mounted under the feed deck 30 and project upwardly through openings in the feed deck so that the periphery of the rollers 32 is slightly above the upper surface of the feed deck 30 and can exert a forward feeding force on a succession of mail pieces placed in the input end 14. A vertical wall 34 defines a mail piece stacking location from which the mail pieces are fed by the nudger rollers 32 along the feed deck 30 and into a transport system (not shown) that transports the mail pieces in a downstream path of travel, as indicated by arrow A, through one or more modules, such as, for example, a separator module and moistening/sealing module. Each of these modules is located generally in the area indicated by reference numeral 36. The mail pieces are then passed to a weighing module 42 (shown in FIG. 2) and a metering/printing module 44 (shown in FIG. 2) located generally in the area indicated by reference numeral 38, and exit the mailing processing system 10 at the output end 16.

Referring to FIG. 2, a block diagram of mail processing system 10 is shown. Mail processing system 10 includes central processing unit (CPU) 40. Display device 22 and keyboard 20 provide a user interface to CPU 40. Weighing module 42, such as a scale, weighs mail pieces and metering/printing module 44, such as a postage meter, applies postage to the mail pieces and manages postage amounts stored therein. Mail processing system 10 also includes dimensioning module 48 for measuring one or more dimensions of a mail piece such as thickness, width and length. Dimensioning module 48 may take any one of many forms known in the art, and may comprise, for example, an array of sensors, such as optical sensors. Mail processing system 10 is of the type that is able to process mixed mail without the need to manually sort the mail based on weight or dimensions. CPU 40 controls all operations of mail processing system 10 as described herein by executing software stored in memory 46, such as a non-volatile memory module.

Stored within memory 46 is a database of information that includes the standard rate tables published by the relevant postal authorities that specify the postage rates for all classes of mail. Within each class of mail, the rate tables specify a particular postage amount that applies to all mail pieces falling within a particular weight range. Specifically, for each class of mail, the tables will specify a maximum weight, known as a weight break, for each level of postage. The weight breaks may vary for different classes of mail. The rate tables may also specify an additional charge for each weight range that applies if a mail piece meets or exceeds certain dimension parameters. In addition, the rate table may also specify additional charges that apply to certain special services requested by a user, such as, for example, c.o.d. service, return receipt service or insurance. Also stored within memory 46 is a processing engine that provides appropriate access to the data stored in the database.

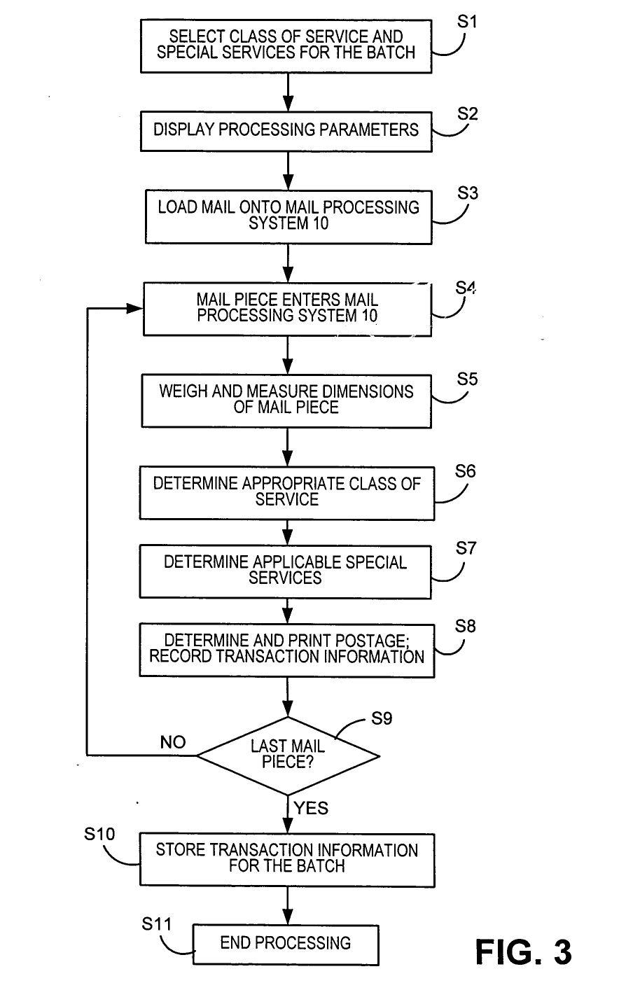

FIG. 3 is a flow diagram illustrating the operation of mail processing system 10 according to the present invention that is capable of processing batches of mail that vary by weight and/or dimension over a number of classes by automatically determining an appropriate class of service for each mail piece in each batch and applying one or more requested special services to the mail in a discriminate manner, i.e., only where it is appropriate. As noted above, operation of mail processing system 10 as described herein is controlled using software that is stored in memory 46 and executed by CPU 40.

Referring to FIG. 3, at step S1, a user selects, using display device 22 and/or keyboard 20 of mail processing system 10, a class of service to be used in the processing of a batch of mail and one or more special services to be applied to each of the mail pieces in the batch. At step S2, the specified processing parameters for the selected class of service and special services, if applicable, are presented to the user on display device 22, and the user is given the opportunity to either accept the parameters and begin the processing of the mail or change one or more of the parameters before processing begins. Once the user is comfortable with and has accepted the processing parameters for the batch, the user, at step S3, loads the batch of mail onto mail processing system 10 where it is sequentially fed for processing. In step S4, a mail piece, in this case the first mail piece in the batch, enters mail processing system 10. At step S5, one or more dimensions of the mail piece, such as the height and width, are measured using dimensioning module 48 and the mail piece is weighed using weighing module 42. The length of the mail piece may also be measured. The measured weight and dimension(s) are stored in memory 46 for use during subsequent processing steps.

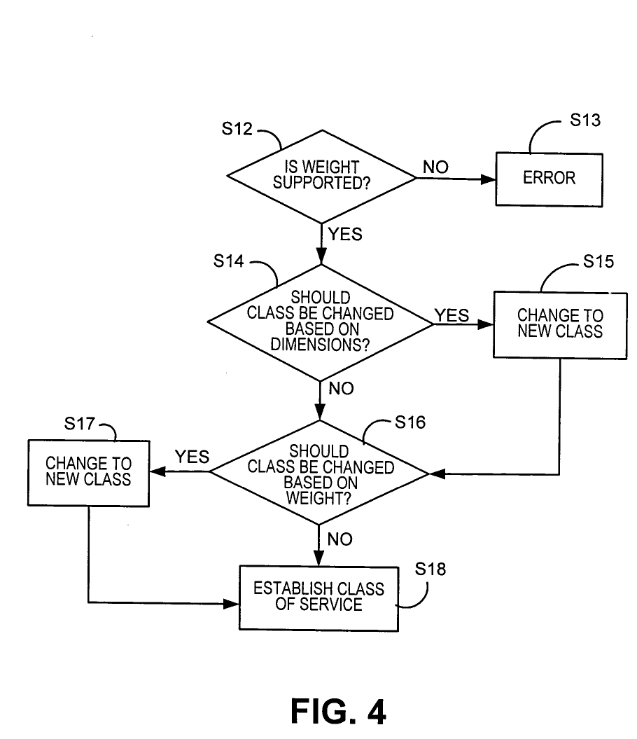

Next, at step S6, an appropriate class of service for the mail piece is determined. Specifically, according to the method described in greater detail in connection with FIG. 4, a determination is made as to whether the class of service originally entered by the user is appropriate for the mail piece, i.e., mail processing system 10 determines whether the mail piece is eligible is for the specified class of service. If not, an appropriate class of service for the mail piece is chosen using a supplemental table generated from information provided in the database stored in memory 46 which specifies the class of service to be used based on the weight and dimension(s) of the mail piece. Specifically, the supplemental table, which is based on rules established and dictated by the applicable postal authority, specifies the appropriate class of service to use to maintain the same standards as the originally chosen class of service when the measured weight and/or dimension(s) rules out the originally chosen class. In other words, the postal authorities dictate the direction in switching between classes based on weight and/or dimension(s). For example, in Germany, the standard letter class is broken in Standard, Compact and Gross classes. These classes of service provide the same standard of mail service, but are limited by weight and dimensions(s) of the mail piece. Standard and Compact support the same dimensions (up to 125 mm in height), but the maximum weight for Standard is 20 grams and for Compact is 50 grams. Gross can support up to 500 grams and also support larger mail pieces than the Standard and Compact classes. In the mail processing system 10, any mail piece for which Standard is the class originally chosen will be processed as Standard if it weighs less than 20 grams and is less that 125 mm in height (the maximum dimension for Standard), will be processed as Compact (class of service changed) if it weighs more than 20 grams but less than 50 grams and is less than 125 mm in height, and will be processed as Gross (class of service changed) if either it weighs more than 50 grams or is greater than 125 mm in height.

After an appropriate class of service is established for the mail piece, a determination is made in step S7 as to whether each of the special services originally requested by the user is applicable to the mail piece, meaning the mail piece is eligible for the specified special service. Many special services are only appropriate for and available to be used with mail pieces that meet certain criteria, such as being of a particular class or group of classes, meeting certain weight and/or dimension limits, and having additional prerequisite special services already designated. At step S8, appropriate postage for the mail piece is determined based on the measured weight and dimension(s) of the mail piece, the class of service established in step S6, which may be the same or different than the class of service originally entered by the user in step S1, and each of the special services that are determined to be applicable in step S7, which may be all or less than all of the special services originally entered by the user in step S1. The appropriate postage amount is determined in this manner using a table generated from the postage rating information provided in the database of information stored in memory 46. Preferably, this table is generated after the completion of step S2. The determined postage amount is applied either directly to the mail piece or to a tape to be affixed to the mail piece using metering/printing module 44. In addition, at step S8, accurate transaction information is stored for the mail piece that preferably includes the measured weight (or weight break) and, possibly, dimension(s) of the mail piece, the class of service established in step S6, the special services determined to be applicable in step S7, and the postage amount actually applied to the mail piece. A postal ID may also be captured, which represents a single class of service or multiple classes of service with the same standards. Next, in step S9, a determination is made as to whether the mail piece just processed is the last mail piece in the batch. If it is not, steps S4 through S8 are repeated for the next mail piece in the batch. Processing continues into this manner until all of the mail pieces in the batch have been processed. At step S10, after the last mail piece in the batch has been processed, the transaction information for the entire batch is stored in memory 46 for subsequent reporting to a postal authority and/or use for accounting purposes by the user. At step S11, processing is complete and the user removes the mail pieces.

Referring to FIG. 4, a flow diagram is provided that illustrates a preferred method of determining the appropriate class of service for a mail piece which, in a preferred embodiment of the present invention, may be implemented in step S6 of FIG. 3. In step S12 a determination is made as to whether the measured weight for the mail piece being processed is supported by any of the classes of service for which mail processing system 10 has been programmed to operate. In other words, mail processing system 10 determines whether a class of service for which it has been programmed exists that would be able to be used to process the mail piece. This feature allows a user to set an upper weight limit of mail pieces that mail processing system 10 will be adapted to handle. If the weight is not supported, then in step S13, an error condition is set and mail processing system 10 will pause. The user is notified that the mail piece cannot be supported by the selected class of service based on the weight of the mail piece. The user will press a clear button on keyboard 22 to eject the invalid mail piece (no indicia is printed on the mail piece). The user may then restart the processing of the batch of mail. If the weight is supported, then, at step S14, a determination is made as to whether the class originally entered by the user in step S1 shown in FIG. 3 should be changed to a different class based on the dimension(s) of the mail piece measured in step S5 shown in FIG. 3. Specifically, mail processing system 10 determines whether the class of service originally entered by the user will support, i.e., is available for, a mail piece having the dimension(s) measured in step S5 of FIG. 3. If the class of service does not support the measured dimension(s), then the class of service must be changed, in step S15, to a class of service that does support the measured dimension(s). Specifically, in step S15, the class of service for the mail piece being processed is changed to the next appropriate class of service that does support the measured dimension(s) based on the rules dictated by the postal authority using the table described in connection with step S6 in FIG. 3.

If a determination is made in step S14 that the original class of service supports the measured dimension(s), or after the original class of service is changed in step S15, the processing proceeds to step S16. In step S16, a determination is either made as to whether the current class associated with the mail piece, which will be either the originally entered class of service if the answer in step S14 is no or the new class established in step S15 if the answer in step S14 is yes, needs to be changed to a different class based on the weight of the mail piece measured in step S5 shown in FIG. 3. Specifically, mail processing system 10 determines whether the current class of service for the mail piece will support, i.e., is available for, a mail piece having the weight measured in step S5 of FIG. 3. If the class of service does not support the measured weight, then the class of service must be changed, in step S17, to a class of service that does support the measured weight. Specifically, in step S17 the class of service for the mail piece being processed is changed to the next appropriate class of service that does support the measured weight based on the rules dictated by the postal authority using the table described in connection with step S6 in FIG. 3. In step S18, the final class of service is established for the mail piece, and will be one of the originally entered class, the class established in step S15 and the class established in step S17 depending on the determinations made at steps S14 and S16. The final class of service that is established in step S18 is the class of service that is used in all subsequent processing of the mail piece shown in FIG. 3, and is a class of service that is appropriate for the mail piece based on the dimension(s) and weight of the mail piece.

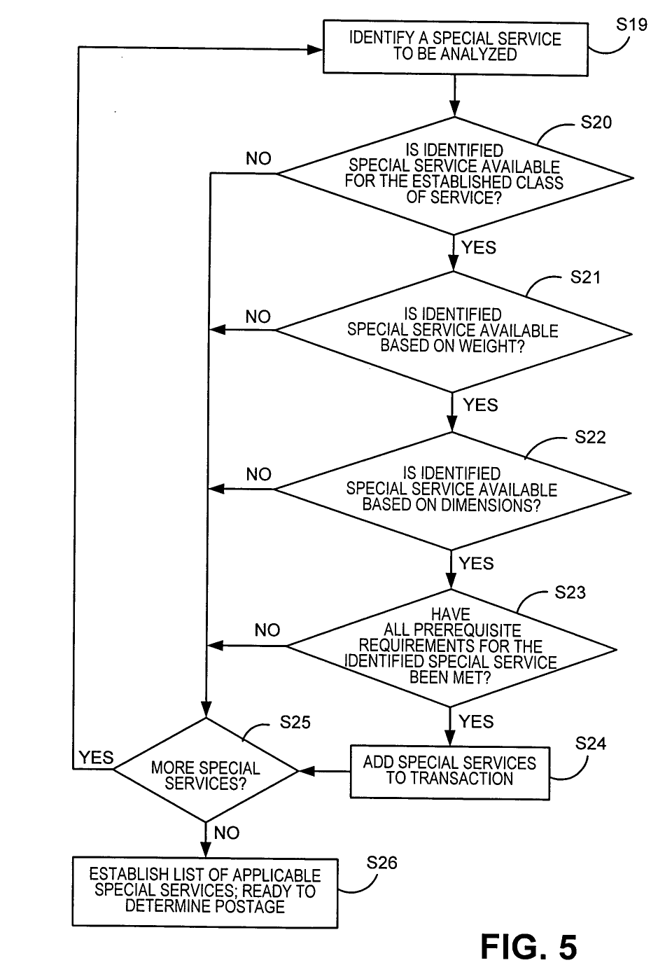

Referring to FIG. 5, a flow diagram is provided that illustrates a preferred method of determining which of a number of special services requested for a mail piece are applicable to the mail piece which, in a preferred embodiment of the present invention, may be implemented in step S7 of FIG. 3. For a special service to be applicable to the mail piece as described herein, the mail piece must be eligible for the special service in question. The method shown in FIG. 5 is based on the premise that many special services are only appropriate for and available to be used with mail pieces that meet certain criteria, such as being of a particular class or group of classes, meeting certain weight and/or dimension limits, and having additional prerequisite special services already designated. In other words, the premise is that certain special services, even if requested and paid for by a user, cannot be used with certain types of mail. In prior art systems, special service fees were applied indiscriminately, i.e., whether it was appropriate or not, without regard to such criteria. According to the present invention, special service fees are applied discriminately, meaning only if the special service in question is appropriate for and available to be used with the mail piece in question.

In the method shown in FIG. 5, special service applicability is determined based on information stored in memory 46. Specifically, memory 46 includes, for each possible special service supported by mail processing system 10, rating information relating to the class or classes of service that may utilize the special service, the weight and/or dimension limits for mail that may utilize the special service, and the prerequisite special services that must also be selected before the special service may be utilized with the mail piece. For ease of reference, this database information will be referred to herein as special services availability information.

Referring again to FIG. 5, in step S19, the processing of each mail piece starts with the step of identifying a requested special service to be analyzed. At the beginning of the processing of each mail piece, this identified special service will be the first special service requested or selected by the user in step S1 of FIG. 3. At step S20, a determination is made, using the special services availability information, as to whether the identified special service is available for the class of service established for the mail piece in step S6 of FIG. 3, and preferably in step S18 shown in FIG. 4.

If, in step S20, the identified special service is determined to be available, then, at step S21, a determination is made as to whether the identified special service is available and appropriate for the mail piece being processed based on the weight of the mail piece measured in step S5 of FIG. 3 using the special services availability information stored in memory 46. If, in step S21, the identified special service is determined to be available, then, at step S21, a determination is made as to whether the identified special service is available and appropriate for the mail piece being processed based on the dimension(s) of the mail piece measured in step S5 of FIG. 3 using the special services availability information stored in memory 46.

If, in step S22, the identified special service is determined to be available, a determination is made at step S23 as to whether all prerequisite requirements, meaning other required special services, applicable to the identified special service have been met. Specifically, if the identified special service has one or more prerequisite requirements associated with it, mail processing system 10 checks whether all of the required prerequisite special services have been selected and have also been determined to be applicable and appropriate for the mail piece. For example, in order for a return receipt for a c.o.d. delivery special service to be available for a mail piece, the c.o.d. special service must have been requested by the user for the mail piece and must have been determined to be appropriate and applicable to the mail piece as described herein. If, in step S23, it is determined that all prerequisite requirements for the identified special services have been met, then the identified special services is determined to be applicable to the mail piece and is saved as part of the transaction information to be used in determining postage for the mail piece in step S8 of FIG. 3. Next, a determination is made at step S25 as to whether other special services requested in step S1 of FIG. 3 need to be analyzed. If so, then processing returns to step S19 and steps S20 through S25 are repeated until all special services selected by the user have been analyzed.

If in any of steps S20, S21, S22 or S23 the identified special service is determined to not be available, then processing proceeds to step S25, where a determination is made as to whether other special services requested in step S1 of FIG. 3 need to be analyzed. If not, then processing for that mail piece is complete. If, however, additional special services remain, the processing proceeds to step S19 and steps S20 through S25 are repeated until all special services selected by the user have been analyzed.

When, at step S25, it is determined that no special services remain, then, at step S26, a final list of special services determined to be applicable to the mail piece is established, which list will be used in determining the postage for the mail piece in step S8 of FIG. 3. Thus, as can be seen, special services are applied discriminately to each mail piece, i.e., only if the mail piece is eligible for each special service based on the special services availability information.

As noted above, under current methods of mail processing, the transaction information that is captured for each batch of mail is not accurate because the transaction information includes fees for special services that were not actually applied to mail pieces. According to an aspect of the present invention, these data capture inaccuracies are eliminated because special services and the associated fees are applied discriminately.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

1. A method for processing a mail piece comprising:
receiving a first class of service from a user for processing said mail piece;
determining at least one physical parameter of said mail piece;
determining whether said first class of service is appropriate for said mail piece using said determined at least one physical parameter, and if said first class of service is not appropriate, determining a second class of service for said mail piece using said determined at least one physical parameter, said second class of service being appropriate for said mail piece;
setting a final class of service for said mail piece, said final class of service being said first class of service if said first class of service is determined to be appropriate and said second class of service if said first class of service is determined to not be appropriate; and
determining a postage amount for said mail piece using said determined at least one physical parameter and said final class of service.

2. The method according to claim 1, further comprising:
applying said determined postage amount to one of said mail piece or a tape to be applied to said mail piece.

3. The method according to claim 1, wherein receiving a first class of service further comprises:
receiving one or more special services to be applied to said mail piece.

4. The method according to claim 3, wherein setting a final class of service further comprises:
determining whether each of said special services is applicable to said mail piece; and
generating a list of applicable special services for said mail piece.

5. The method according to claim 4, wherein determining said postage amount further comprises:
determining a postage amount for said mail piece using said determined physical parameter, said final class of service, and said list of applicable special services.

6. The method according to claim 4, wherein determining whether each of said special services is applicable to said mail piece is based on said final class of service, said determined physical parameter, and a determination as to whether all applicable prerequisite requirements have been satisfied.

7. The method according to claim 4, further comprising:
storing transaction information for said mail piece, said transaction information including said determined postage amount, said final class of service and said list of applicable special services.

8. The method according to claim 1, further comprising:
storing transaction information for said selected mail piece, said transaction information including said determined postage amount and said final class of service.

9. The method according to claim 1, wherein said at least one physical parameter includes a weight and at least one dimension of said mail piece and determining whether said first class of service is appropriate and determining a second class of service comprise:
determining whether said first class of service supports said at least one dimension and, if not, finding a third class of service that supports said at least one dimension;
determining whether one of said first class of service and said third class of service, if applicable, supports said weight and, if not, finding a fourth class of service that support said weight;
setting said second class of service equal to said third class of service if said first class of service does not support said at least one dimension and said third class of service supports said weight; and
setting said second class of service equal to said fourth class of service if neither of said first class of service and said third class of service, if applicable, support said weight;
wherein said first class of service is appropriate if said first class of service supports both said at least one dimension and said weight.

10. The method according to claim 9, wherein finding a third class and finding a fourth class further comprise:
determining said third class of service and said fourth class of service based on predetermined rules for switching classes.

11. A mail processing system for processing a mail piece comprising:
a postage meter for applying postage values to said mail piece;
a scale for weighing said mail piece;
a dimensioning module for determining at least one dimension of said mail piece;
a central processing unit controlling operation of said postage meter, said scale and said dimensioning module; and
a memory storing postage rating information and software executable by said central processing unit, said software including instructions for performing:
receiving a first class of service from a user for processing said mail piece;
determining a weight of said mail piece using said scale and at least one dimension of said mail piece using said dimensioning module;
determining whether said first class of service is appropriate for said mail piece using said determined weight and said determined at least dimension, and if said first class of service is not appropriate, determining a second class of service for said mail piece using said determined weight and said determined at least one dimension, said second class of service being appropriate for said mail piece;
setting a final class of service for said mail piece, said final class of service being said first class of service if said first class of service is determined to be appropriate and said second class of service if said first class of service is determined to not be appropriate; and
determining a postage amount for said mail piece using said determined weight, said determined at least one dimension, said final class of service and said postage rating information.

12. The mail processing system according to claim 11, wherein said software further includes instructions for causing said postage meter to apply said determined postage amount to one of said mail piece or a tape to be applied to said mail piece.

13. The mail processing system according to claim 11, wherein receiving a first class of service further comprises:
receiving one or more special services to be applied to said mail piece.

14. The mail processing system according to claim 12, wherein setting a final class of service further comprises:
determining whether each of said special services is applicable to said mail piece using said postage rating information, said postage rating information including special service availability information, and
generating a list of applicable special services for said mail piece.

15. The mail processing system according to claim 14, wherein determining a postage amount for said mail piece further comprises:
determining a postage amount for said mail piece using said determined weight, said determined at least one dimension, said final class of service, and said list of applicable special services.

16. The mail processing system according to claim 14, wherein determining whether each of said special services is applicable to said mail piece is based on said final class of service, said determined weight, said determined at least one dimension, and a determination as to whether all applicable prerequisite requirements have been satisfied.

17. The mail processing system according to claim 14, wherein said software further includes instructions for storing transaction information for said mail piece in said memory, said transaction information including said determined postage amount and said final class of service.

18. The mail processing system according to claim 11, wherein said software further includes instructions for storing transaction information for said mail piece in said memory, said transaction information including said determined postage amount, said final class of service and said list of applicable special services.

19. The mail processing system according to claim 11, wherein determining whether said first class of service is appropriate and determining a second class of service comprise:
determining whether said first class of service supports said determined t least one dimension and, if not, finding a third class of service that supports said determined at least one dimension;
determining whether one of said first class of service and said third class of service, if applicable, supports said determined weight and, if not, finding a fourth class of service that support said determined weight;
setting said second class of service equal to said third class of service if said first class of service does not support said at least one dimension and said third class of service supports said weight; and
setting said second class of service equal to said fourth class of service if neither of said first class of service and said third class of service, if applicable, support said determined weight;
wherein said first class of service is appropriate if said first class of service supports both said determined at least one dimension and said determined weight.

20. The mail processing system according to claim 19, wherein finding a third class and finding a fourth class further comprise:
determining said third class of service and said fourth class of service based on predetermined rules for switching classes.

21. The method according to claim 1, wherein said at least one physical parameter includes a weight and at least one dimension of said mail piece.

22. A method of processing mail pieces comprising:
establishing a default class of service for processing said mail pieces;
establishing a threshold value for at least one physical parameter of said mail pieces;
determining an actual value for said at least one physical parameter of a mail piece;
using said actual vale and said threshold value to determine if said default class of service is appropriate for said mail piece; and
if said default class of service is not appropriate, using a different class of service to process said mail piece.

23. The method according to claim 22, wherein said at least one physical parameter includes a weight and at least one dimension of said mail piece.
